(19) United States
(12) Patent Application Publication
(10) Pub. No.: US 2006/0260497 A1
(43) Pub. Date: Nov. 23, 2006

(54) Apparatus and method for toilet training

(76) Inventors: Ann Neale, San Diego, CA (US); Tamara Monosoff, Walnut Creak, CA (US)

Correspondence Address: WEST & ASSOCIATES, A PC, 2815 MITCHELL DRIVE, SUITE 209, WALNUT CREEK, CA, 94598, US

(21) Appl. No.: 11/439,313

(22) Filed: May 22, 2006

Related U.S. Application Data
(60) Provisional application No. 60/683,415, filed on May 20, 2005.

(51) Int. Cl. G03G 15/32

(52) U.S. Cl. 101/494

(57) ABSTRACT

A toilet training apparatus comprising a central sheet and at least one extension associated with the central sheet, said at least one extension having a shape such that if the central sheet is placed in a commode of a toilet, at least one extension is in at least partial contact with a portion of the interior of said commode. In some embodiments the central sheet is comprised of a material that will allow urine to at least partially pass through it. In some embodiments, the central sheet can include a design.

### CLAIM OF PRIORITY

This application claims the benefit of priority under 35 U.S.C. 119(e) to U.S. Provisional Patent Application No. 60/683,415 filed May 20, 2005.

### BACKGROUND

1. Field of the Invention

The present disclosure is related to a method and apparatus for toilet training persons.

2. Background

Toilet training of children has long been a difficult and time consuming process for parents. It is often difficult for parents to encourage children to use the toilet. Thus, parents must devise new and creative ways to encourage their children to use the toilet.

Given the anatomical differences between the sexes, there is a further challenge when teaching male children to use the toilet. Male children must be taught to urinate from a standing position as well as from a seated position. With male children, urinating from a standing position can lead secondary problem related to aim. Male children must be taught how to aim correctly to prevent them from soiling the areas around the toilet.

Current toilet targets exist which float on the surface of the water inside a commode, such as described in U.S. Pat. No. 5,117,515, issued to White on Aug. 15, 1991. Such training apparatuses are free to float on the water surface and can freely travel on the water surface and thus move around the commode. This can be problematic for training male children as they may chase the apparatus as it travels around the commode on the water surface and soil the surrounding areas.

What is needed is a method and apparatus for toilet training children that encourages children to use the toilet in a manner resulting in a minimal amount of soiling of the surrounding area.

### BRIEF DESCRIPTION OF THE DRAWINGS

FIG. 1 depicts one embodiment of an apparatus for toilet training a child.

FIG. 2 depicts an alternate embodiment of the apparatus depicted in FIG. 1.

FIG. 3 depicts an alternate embodiment of the apparatus depicted in FIG. 1.

### DETAILED DESCRIPTION

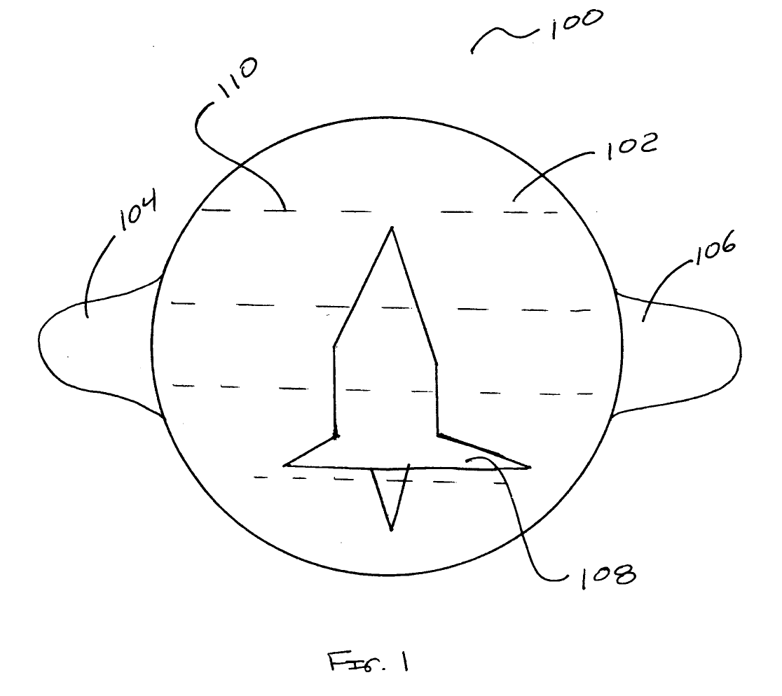

FIG. 1 depicts one embodiment of an apparatus 100 for toilet training. In the embodiment shown in FIG. 1, the apparatus comprises a central sheet of material 102 having two extensions 104 106 on opposing sides of the central sheet 102. In some embodiments the central sheet can have various logos and/or designs 108 printed, embedded or otherwise associated with the central sheet 102. In alternate embodiments the central sheet may not have any designs. In some embodiments, the central sheet 102 can include one or more slits 110.

In the embodiment shown in FIG. 1, the central sheet 102 is comprised of a material that is capable of floating on or just below the surface of water 102 and/or other liquid which may be present in a toilet bowl. In some embodiments, the central sheet 102 can be a paper product. However, in alternate embodiments the central sheet 102 can be comprised of any known and/or convenient material which is capable of floating on the surface of or just below the surface of water and/or any liquid which may be present in a toilet bowl. In some embodiments, the central sheet 102 can be comprised of a material which is capable of being disposed of using the conventional flushing mechanism of a toilet. That is, the material is considered “flushable.”

In some embodiments the central sheet 102 can be comprised of a material that when struck by a stream of urine will break, tear, dissolve or otherwise give-way such that the stream of urine substantially passes through the central sheet 102 and is not, to any significant degree, reflected by the central sheet 102. In some embodiments, the central sheet can include a plurality of perforations or slits 110 configured in any known and/or convenient pattern to facilitate the passing of a urine stream through the central sheet. In alternate embodiment, any other known and/or convenient method, system and/or material can be used to allow a stream of urine to substantially pass through the central sheet 102.

In some embodiments, the central sheet 102 can have dimensions such that the central sheet 102 is approximately the same geometric shape as the surface of the water in the commode of a typical toilet. However, in alternate embodiments, the central sheet 102 can have any convenient shape and/or dimensions.

In the embodiment shown in FIG. 1, the apparatus 100 includes two extensions 104 106. However, in alternate embodiment, the apparatus can include any convenient number of extensions. In some embodiments, the apparatus 100 can include a single extension 104 located only in one area along the perimeter of the central sheet 102. In alternate embodiments, the apparatus can include a single extension 104 which is continuous around the perimeter of the central sheet 102. In still further alternate embodiments, the apparatus 100 can include three extensions equidistantly spaced around the perimeter of the central sheet 102. In still further alternate embodiments, the apparatus 100 can include four extension randomly located at the perimeter of the central sheet 102. In various embodiments, the apparatus 100 can include any convenient number of extensions located at any convenient location and associated in any convenient manner with the central sheet 102.

In the embodiment shown in FIG. 1, the central sheet 102 and the two extensions 104 106 are comprised of a single material and are integral. However, in alternate embodiments the central sheet 102 and one or more of the extensions can be comprised of two or more different materials. In alternate embodiments, the central sheet 102 and one or more of the extensions 104 106 can be associated in any known and/or convenient manner.

In the embodiment shown in FIG. 1, the extensions 104 106 are positioned and dimensioned such that when the central sheet 102 of the apparatus 100 is placed on the surface of the water in a typical commode, at least one of the extensions 104 106 can be in at least partial contact with an interior portion of the commode. In alternate embodiments, the extensions 104 106 can be shaped and dimensioned such that at least one of the plurality of extensions is in at least partial contact with at least one interior portion of the commode.

In still further alternate embodiments, the central sheet can be comprised of any material that is capable of being held on the surface of water or just below the surface of water by the two extensions 104 106.

In operation, the apparatus 100 is placed on the surface of the water and/or other liquid in the commode such that at least one of the extensions, if present, is in at least partial contact with an interior portion of the commode and the central sheet 102 covers at least some of the water in the commode. A person can then urinate on the central sheet 102. The designs 108 can be used to encourage the person to aim for the appropriate area within the commode.

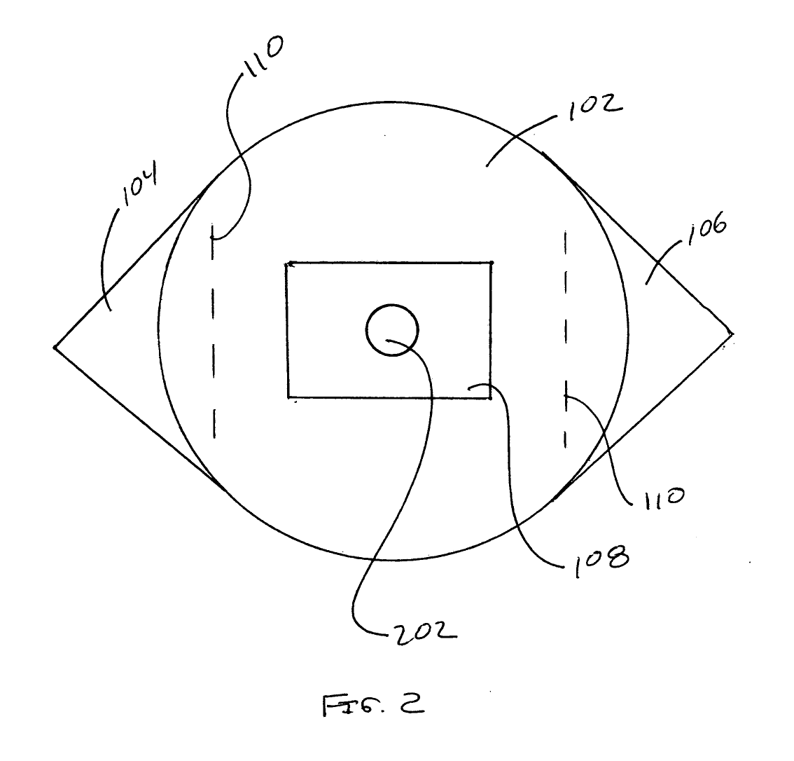

FIG. 2 depicts an alternate embodiment of the apparatus shown in FIG. 1. In the embodiment shown in FIG. 2, the central sheet can be substantially round and has two integral extensions 104 106. However, in alternate embodiments, the central sheet 102 can have any convenient number of extensions and/or no extensions. In some embodiments, the extensions 104 106 can be integral and/or coupled with the central sheet 102. Additionally, the central sheet 102 can have any known and/or convenient geometric properties.

In the embodiment shown in FIG. 2, the central sheet 102 can include an aperture 202. In the embodiment shown in FIG. 2, the aperture 202 is circular and centrally located within the central sheet 102. However, in alternate embodiments the aperture 202 can have any known and/or convenient shape and/or can be located in any convenient location within the central sheet 102.

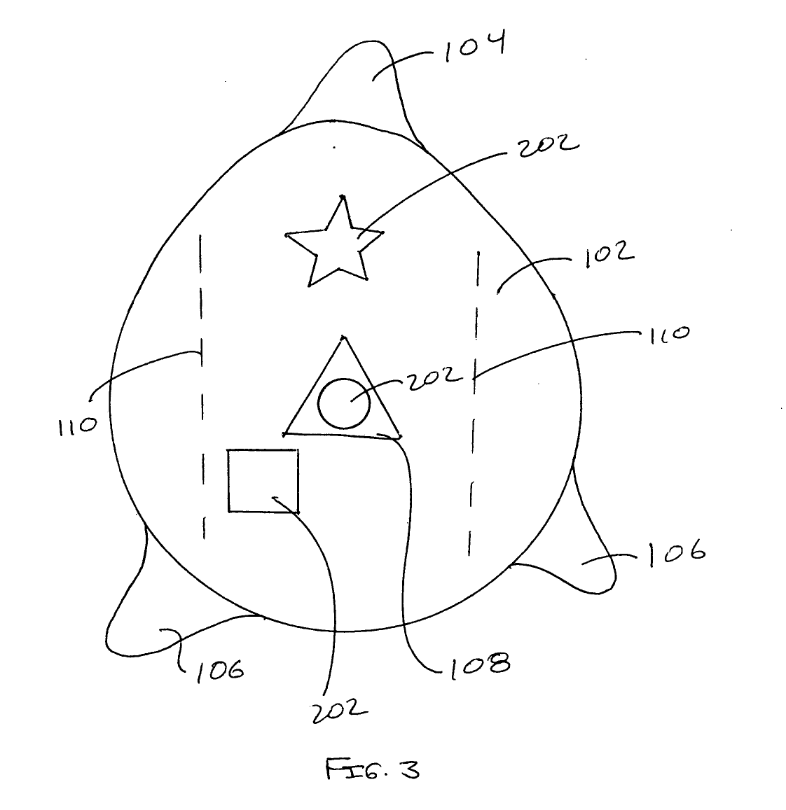

FIG. 3 depicts an alternate embodiment of the apparatus shown in FIG. 1. In the embodiment shown in FIG. 3, the central sheet 102 can be substantially oval and/or have any known and/or convenient geometric properties. In the embodiment shown in FIG. 3, the central sheet 102 can include one or more apertures 202 which can be located in any convenient location on the central sheet 102 and can have any known and/or convenient shapes.

In the embodiment shown in FIG. 3, the central sheet can include one more indicia 108 indicative of desired urination locations. In some embodiments, the indicia and/or any convenient component of the central sheet 102 can include and/or be comprised of material such that a change in color can occur when the material is exposed to urine and/or any known and/or convenient material.

In the embodiment shown in FIG. 3, the central sheet can include one more indicia 108 indicative of desired urination locations. In some embodiments, the indicia and/or any convenient component of the central sheet 102 can include and/or be comprised of material such that is luminescent.

In the embodiment shown in FIG. 3, the central sheet 102 can include, be impregnated with and/or otherwise couple with a germicidal compound adapted to inhibit and/or destroy bacteria, viruses and/or other selected atoms, elements, molecules and/or compounds.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1) A toilet training apparatus comprising:
a central sheet; and
at least one extension associated with the central sheet, said at least one extension having a shape such that if the central sheet is placed in a commode of a toilet, at least one extension is in at least partial contact with a portion of the interior of said commode.

2) The toilet training apparatus of claim 1, wherein said central sheet includes at least one slit.

3) The toilet training apparatus of claim 1, wherein said central sheet includes at least one aperture.

4) The toilet training apparatus of claim 2, wherein said central sheet includes at least one aperture.

5) The toilet training apparatus of claim 1, wherein said central sheet includes indicia indicative of a desired target urination location.

6) The toilet training apparatus of claim 2, wherein said central sheet includes indicia indicative of a desired target urination location.

7) The toilet training apparatus of claim 3, wherein said central sheet includes indicia indicative of a desired target urination location.

8) The toilet training apparatus of claim 4, wherein said central sheet includes indicia indicative of a desired target urination location.

9) The toilet training apparatus of claim 1, wherein said central sheet is adapted to float on or just below a surface of water within a commode.

10) The toilet training apparatus of claim 9, wherein said at least one extensions is adapted to selectively engage the interior surface of said commode.

11) The toilet training apparatus of claim 10, wherein said central sheet is comprised of a flushable paper.

12) A toilet training apparatus comprising:
a substantially round central sheet adapted to float on or just below a surface of water within a commode;
two extensions, integral with said central sheet adapted to engage the interior surface walls of said commode.
